(19) United States
(12) Patent Application Publication
(10) Pub. No.: US 2012/0167471 A1
(43) Pub. Date: Jul. 5, 2012

(54) HOUSING WITH BALL-JOINTS

(75) Inventors: LIAN-JUN ZHANG, Shenzhen City (CN); FENG DAI, Shenzhen City (CN); SHOU-JI LIU, Shenzhen City (CN); TE-SHENG JAN, Tu-Cheng (TW); YU-TAO CHEN, Tu-Cheng (TW); CHUN-CHE YEN, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/105,884

(22) Filed: May 11, 2011

(30) Foreign Application Priority Data
Dec. 29, 2010 (CN) 201010612231.X

(51) Int. Cl. E05D 7/00

(52) U.S. Cl. 49/381

(57) ABSTRACT

A housing with ball-joints includes a rotatable member, a main body and two ball-joints. Each of the ball-joints includes a ball head and a corresponding shaft hole. The ball-joints are received in the shaft holes correspondingly. Each ball head is formed by two hemispherical elements. One of the hemispherical elements is smaller than the other, and a bottom of the smaller hemispherical element is connected to a top portion of the larger hemispherical element, Where the hemispherical elements meet, a ring-shaped intersection line is formed.

### BACKGROUND

1. Technical Field

The present disclosure relates to a housing with ball-joints.

2. Description of Related Art

Usually, housings include a rotatable member and ball-joints at both sides of the rotatable member, each of the ball-joints includes a ball head and a shaft hole, and the ball heads are received in the shaft holes correspondingly. However, the rotatable member can too easily fall apart from the housing.

Thus, what is needed is a housing with stable and durable ball-joints.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of a housing with ball-joints, according to an exemplary embodiment.

FIG. 2 is a schematic, exploded view of the housing with ball-joints of FIG. 1.

FIG. 3 is a schematic, enlarged isometric view of part III of FIG. 2.

FIG. 4 is a schematic, enlarged isometric view of part IV of FIG. 2.

### DETAILED DESCRIPTION

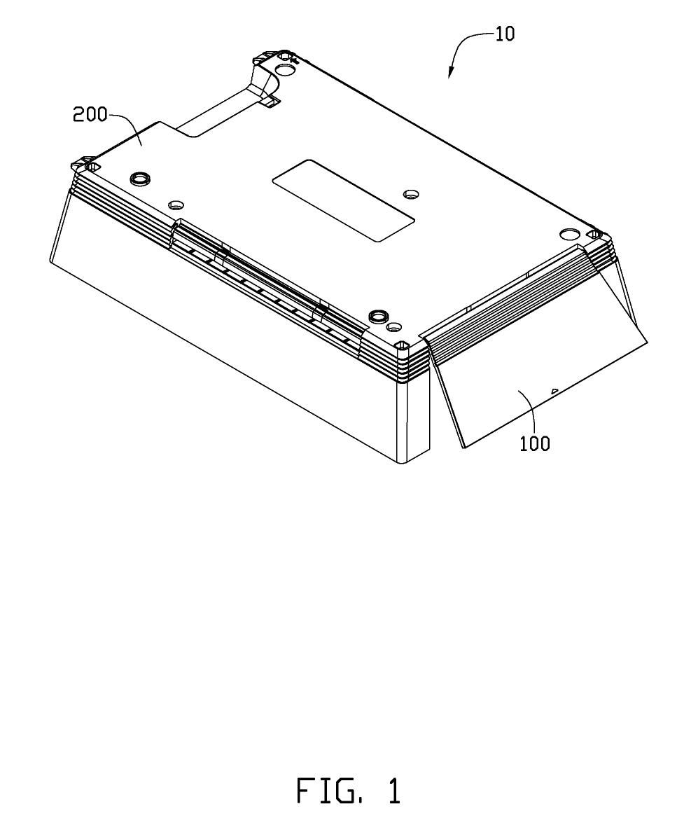

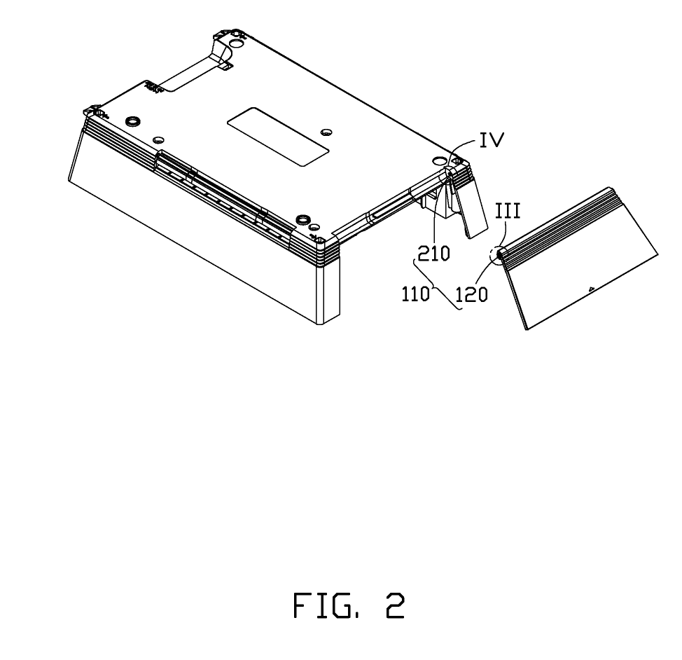

Referring to FIGS.1 and 2, a housing 10 with ball-joints according to an embodiment is disclosed. The housing can be made of plastic. The housing 10 with ball-joints includes a rotatable member 100, a main body 200, and two ball-joints 110 respectively located at two opposite sides of the rotatable member 100.

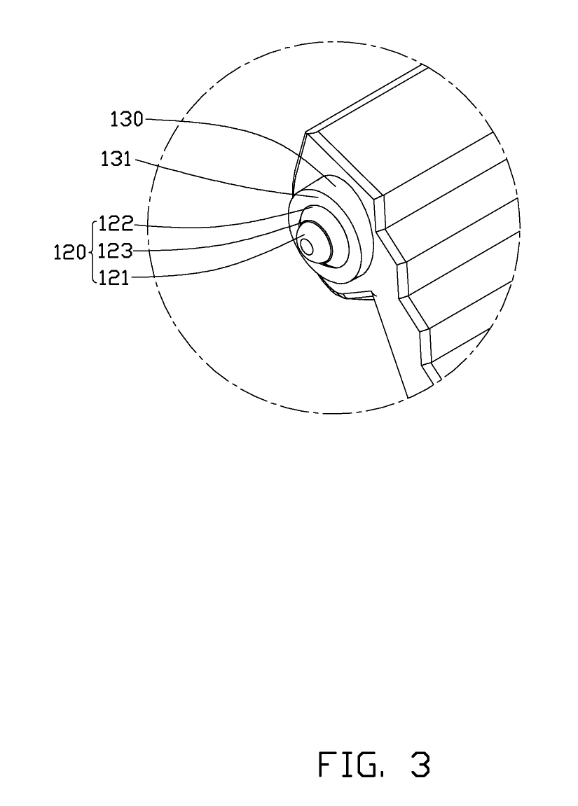

Each of the ball-joints 110 includes a ball head 120 and a shaft hole 210. Referring to FIG. 3, the ball head 120 is cap-shaped and formed by two substantially hemispherical elements 121, 122. The hemispherical element 121 is smaller than the hemispherical element 122. The hemispherical element 121 is connected to the hemispherical element 122, with its bottom connected to the top portion of hemispherical element 122. A ring-shaped intersection line 123 is formed where the hemispherical elements 121 and 122 meet. Two protrusions 130 are respectively and symmetrically formed on two opposite end surfaces of the rotatable member 100. Each of the protrusions 130 includes a surface 131 formed facing away from the rotatable member 100. The ball heads 120 are formed on the surfaces 131 correspondingly.

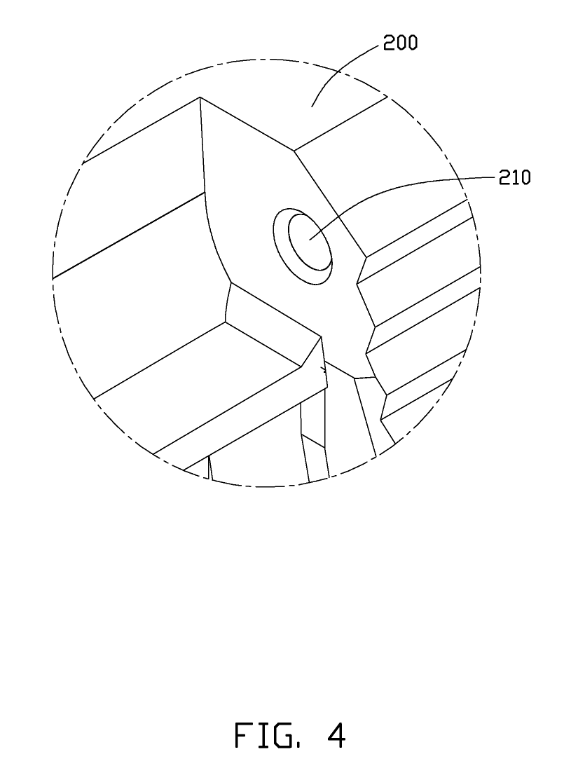

Referring to FIG. 4, two shaft holes 210 are defined on the main body 200 for receiving the ball heads 120 correspondingly. Each of the shaft holes 210 is also cap-shaped and is sized to engage with the corresponding hemispherical element 121 and 122. Compared to traditional products, stability and durability of the ball-joints is improved.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A housing with ball-joints, comprising:
a rotatable member;
a main body and
two ball-joints, wherein each of the ball-joints includes a ball head and a corresponding shaft hole, the ball-joints are received in the shaft holes correspondingly, each ball head is formed by two hemispherical elements, one of the hemispherical elements is smaller than the other, and a bottom of the smaller hemispherical element is connected to a top portion of the larger hemispherical element, where the hemispherical elements meet, a ring-shaped intersection line is formed.

2. The housing with ball-joints of claim 1, further comprising two protrusions respectively and symmetrically formed on two opposite end surfaces of the rotatable member, the ball heads are formed on the surfaces correspondingly.

3. The housing with ball-joints of claim 1, wherein the housing is made of plastic.
